(19) United States
(12) Patent Application Publication
(10) Pub. No.: US 2014/0166118 A1
(43) Pub. Date: Jun. 19, 2014

(54) TIRE PRESSURE CONTROL SYSTEM FOR A SELF-INFLATING TIRE

(71) Applicants: Charles STEPHENS, Seattle, WA (US); John Michael Morris, Auburn, WA (US)

(72) Inventors: Charles STEPHENS, Seattle, WA (US); John Michael Morris, Auburn, WA (US)

(73) Assignee: Norgren GT Development Corporation, Auburn, WA (US)

(21) Appl. No.: 13/714,783

(22) Filed: Dec. 14, 2012

(51) Int. Cl. B60S 5/04

(52) U.S. Cl. CPC B60S 5/04
USPC 137/15.01; 137/224

(57) ABSTRACT

A tire pressure control system (100) for a self-inflating tire includes a left coupling conduit (128) in fluid communication with a left tube end (104) of a peristaltic pump tube (102), a right coupling conduit (129) in fluid communication with a right tube end (105), a bypass conduit (130) extending between and coupling the left coupling conduit (128) and the right coupling conduit (129), and a bypass valve (150) configured to block the bypass conduit (130) when the tire pressure is less than a predetermined target pressure. When the bypass valve (150) substantially blocks the bypass conduit (130), then pressurized air generated in the peristaltic pump tube (102) is forced into the self-inflating tire. When the bypass valve (150) does not block the bypass conduit (130), then air is allowed to circulate within the peristaltic pump tube (102).

### BACKGROUND OF THE INVENTION

1. Field of the Invention

The invention is related to the field of tires, and more particularly, to self-inflating tires.

2. Description of the Prior Art

A self-inflating tire includes a mechanism for pressurizing ambient air and adding the pressurized air to the self-inflating tire. This has benefits including removing the need for an operator to check and maintain tire pressure. This has benefits including adding air pressure to the tire when needed and without delay. This has benefits including reacting immediately to environmental changes Immediate response in adding air pressure to a self-inflating tire improves road handling and greatly reduces improper tire wear.

A self-inflating tire may use a peristaltic pump tube to generate pressurized air and add the pressurized air to the self-inflating tire. The peristaltic pump tube may be located within the self-inflating tire, such as built into a sidewall of the self-inflating tire. As a result, rotation of the tire may compress a section of the peristaltic pump tube in a rotating manner, without need for an extra power source for pressurizing air.

The self-inflating tire must be able to draw in the ambient air and only provide pressurized air to the self-inflating tire as needed. The self-inflating tire needs a pressure control system that is simple, inexpensive, and robust. The self-inflating tire needs a pressure control system that supplies pressurized air as needed and without leakage. The self-inflating tire needs a pressure control system that is adjustable so the tire pressure can be easily set from the exterior of the tire.

### ASPECTS OF THE INVENTION

In some aspects of the invention, a tire pressure control system for a self-inflating tire comprises:
a left coupling conduit in fluid communication with a left tube end of a peristaltic pump tube;
a right coupling conduit in fluid communication with a right tube end of the peristaltic pump tube;
a bypass conduit extending between and coupling the left coupling conduit and the right coupling conduit; and
a bypass valve configured to block the bypass conduit when the tire pressure is less than a predetermined target pressure, wherein when the bypass valve substantially blocks the bypass conduit, then pressurized air generated in the peristaltic pump tube is forced into the self-inflating tire and wherein when the bypass valve does not block the bypass conduit, then air is allowed to circulate within the peristaltic pump tube.

Preferably, the tire pressure control system further comprises a left outlet check valve in the left coupling conduit and a right outlet check valve in the right coupling conduit, wherein the left outlet check valve and the right outlet check valve are located between the bypass conduit and the self-inflating tire.

Preferably, when the bypass valve substantially blocks the bypass conduit, then pressurized air generated in the peristaltic pump tube is added to the self-inflating tire until the tire pressure substantially equals the predetermined target pressure.

Preferably, the tire pressure control system further comprises an adjuster body configured to be manipulated to select the predetermined target pressure.

Preferably, the bypass valve comprises an adjuster body configured to be manipulated to select the predetermined target pressure, a movable pressure sensing element, an anvil extending from the pressure sensing element, and a biasing device positioned between the adjuster body and the pressure sensing element, with the biasing device placing a biasing force against the pressure sensing element, wherein the predetermined target pressure is related to the biasing force.

Preferably, the tire pressure control system further comprises a left inlet check valve positioned in the left tube end and configured to admit air into the peristaltic pump tube when the peristaltic pump tube is being compressed in a clockwise (CW) direction and when the bypass valve substantially blocks the bypass conduit, and a right inlet check valve positioned in the right tube end and configured to admit air into the peristaltic pump tube when the peristaltic pump tube is being compressed in a counter-clockwise (CCW) direction and when the bypass valve substantially blocks the bypass conduit.

Preferably, the predetermined target pressure comprises an adjustable target pressure.

Preferably, the predetermined target pressure comprises a manually adjustable target pressure.

In some aspects of the invention, a tire pressure control system for a self-inflating tire comprises:
a left coupling conduit in fluid communication with a left tube end of a peristaltic pump tube;
a right coupling conduit in fluid communication with a right tube end of the peristaltic pump tube;
a bypass conduit extending between and coupling the left coupling conduit and the right coupling conduit; and
a bypass valve configured to block the bypass conduit when the tire pressure is less than a predetermined target pressure, with the bypass valve comprising:
   an adjuster body configured to be manipulated to select a predetermined target pressure;
   a movable pressure sensing element;
   an anvil extending from the pressure sensing element; and
   a biasing device positioned between the adjuster body and the pressure sensing element, with the biasing device placing a biasing force against the pressure sensing element, wherein the predetermined target pressure is related to the biasing force;
wherein when the bypass valve substantially blocks the bypass conduit, then pressurized air generated in the peristaltic pump tube is forced into the self-inflating tire and wherein when the bypass valve does not block the bypass conduit, then air is allowed to circulate within the peristaltic pump tube.

In some aspects of the invention, a method of forming a tire pressure control system for a self-inflating tire comprises:
providing a left coupling conduit in fluid communication with a left tube end of a peristaltic pump tube;
providing a right coupling conduit in fluid communication with a right tube end of the peristaltic pump tube;
providing a bypass conduit extending between and coupling the left coupling conduit and the right coupling conduit; and
providing a bypass valve configured to block the bypass conduit when the tire pressure is less than a predetermined target pressure, wherein when the bypass valve substantially blocks the bypass conduit, then pressurized air generated in the peristaltic pump tube is forced into the self-inflating tire and wherein when the bypass valve does not block the bypass conduit, then air is allowed to circulate within the peristaltic pump tube.

Preferably, the method further comprises providing a left outlet check valve in the left coupling conduit and providing a right outlet check valve in the right coupling conduit, wherein the left outlet check valve and the right outlet check valve are located between the bypass conduit and the self-inflating tire.

Preferably, when the bypass valve substantially blocks the bypass conduit, then pressurized air generated in the peristaltic pump tube is added to the self-inflating tire until the tire pressure substantially equals the predetermined target pressure.

Preferably, the method further comprises providing an adjuster body configured to be manipulated to select the predetermined target pressure.

Preferably, providing the bypass valve comprises providing an adjuster body configured to be manipulated to select the predetermined target pressure, providing a movable pressure sensing element, providing an anvil extending from the pressure sensing element, and providing a biasing device positioned between the adjuster body and the pressure sensing element, with the biasing device placing a biasing force against the pressure sensing element, wherein the predetermined target pressure is related to the biasing force.

Preferably, the method further comprises providing a left inlet check valve positioned in the left tube end and configured to admit air into the peristaltic pump tube when the peristaltic pump tube is being compressed in a clockwise (CW) direction and when the bypass valve substantially blocks the bypass conduit, and providing a right inlet check valve positioned in the right tube end and configured to admit air into the peristaltic pump tube when the peristaltic pump tube is being compressed in a counter-clockwise (CCW) direction and when the bypass valve substantially blocks the bypass conduit.

Preferably, the predetermined target pressure comprises an adjustable target pressure.

Preferably, the predetermined target pressure comprises a manually adjustable target pressure.

### BRIEF DESCRIPTION OF THE DRAWINGS

The same reference number represents the same element on all drawings. It should be understood that the drawings are not necessarily to scale.

FIG. 1 shows a tire pressure control system for a self-inflating tire according to the invention.

FIG. 2 shows the tire pressure control system wherein a compression point/pressure front is being generated in a peristaltic pump tube as the self-inflating tire rotates.

FIG. 3 shows the tire pressure control system wherein a compression point/pressure front is being generated in the peristaltic pump tube as the self-inflating tire rotates.

### DETAILED DESCRIPTION OF THE INVENTION

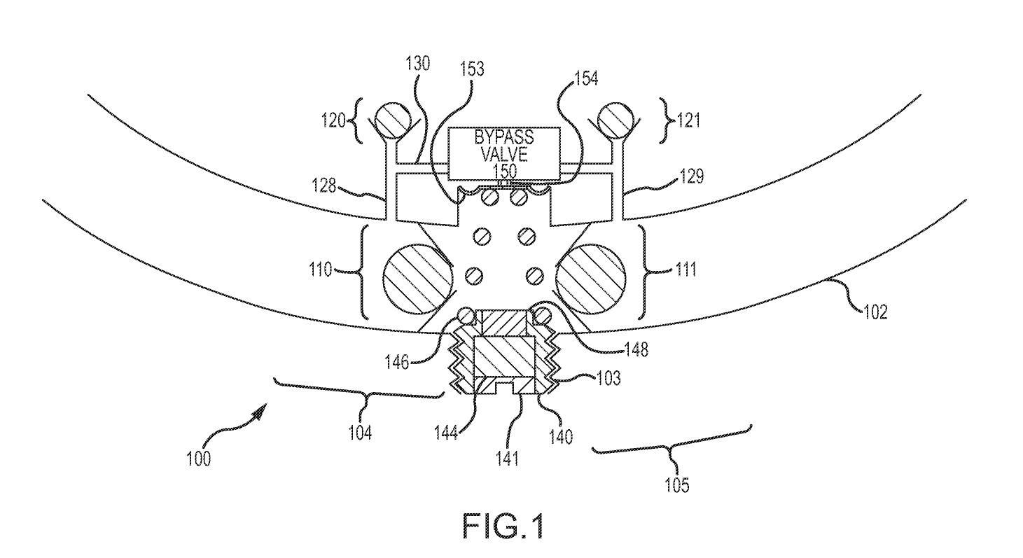

FIGS. 1-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 shows a tire pressure control system 100 for a self-inflating tire according to the invention. The tire pressure control system 100 includes a peristaltic pump tube 102 that is coupled to a tire (not shown) by a left coupling conduit 128 and a right coupling conduit 129. The peristaltic pump tube 102 may draw in and pressurize ambient air, wherein the pressurized ambient air may be added to the tire by the peristaltic pump tube 102 under control of the tire pressure control system 100. The tire pressure control system 100 therefore may maintain an essentially constant air pressure within the tire. The tire pressure control system 100 may maintain a tire pressure at about a predetermined target pressure.

The tire pressure control system 100 may increase the air pressure inside the tire. The tire pressure control system 100 may increase the air pressure in the tire until the air pressure is equal to or greater than the predetermined target pressure. The tire pressure control system 100 therefore may compensate for leakage and/or pressure loss in the tire. The tire pressure control system 100 in some embodiments will not lower the air pressure within the tire, such as where the tire is over-inflated.

The tire pressure control system 100 includes a bypass valve 150 that can control the operation of the peristaltic pump tube 102 and can operate to allow the peristaltic pump tube 102 to add air volume to the self-inflating tire and increase the air pressure in the self-inflating tire. The bypass valve 150 is located in a bypass conduit 130 that extends between, and is in fluidic communication with, the left coupling conduit 128 and the right coupling conduit 129. The bypass valve 150 can comprise any suitable valve. In some embodiments, the bypass valve 150 comprises a double poppet valve. In other embodiments, the bypass valve 150 comprises a pinch valve.

The peristaltic pump tube 102 may comprise a substantially annular, substantially flexible tube structure. The peristaltic pump tube 102 in some embodiments is not fully continuous but has a left tube end 104 and a right tube end 105. The peristaltic pump tube 102 may be squeezed in a rotating manner to generate a moving compression point/pressure front as the tire is rotated. The peristaltic pump tube 102 may comprise a bi-directional peristaltic pump, wherein rotation in either direction may operate to create pressurized air. The bi-directional nature of the peristaltic pump is reflected in the symmetric nature of the inlet check valves and the outlet check valves (discussed below).

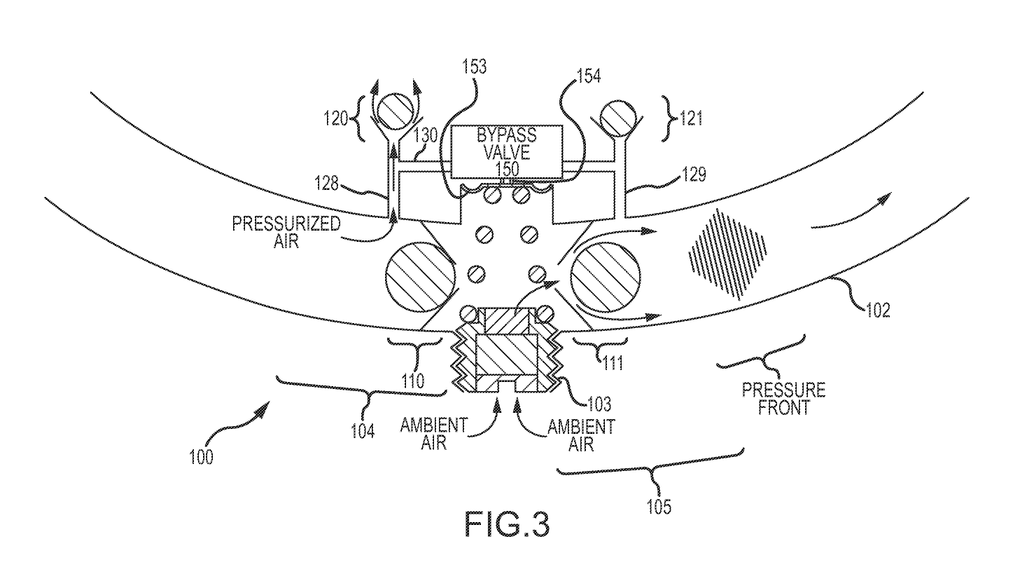

The peristaltic pump tube 102 includes a left inlet check valve 110 and a right inlet check valve 111 in the embodiment shown. The left inlet check valve 110 is positioned on a left side of the inlet fitting 103 in the left tube end 104. The left inlet check valve 110 operates to allow ambient air to be drawn into the left side of the peristaltic pump tube 102 in the figure. The left inlet check valve 110 is configured to admit air into the peristaltic pump tube 102 when the peristaltic pump tube 102 is being compressed in a clockwise (CW) direction and when the bypass valve 150 is substantially blocking the bypass conduit 130 (see FIG. 3 and the accompanying text). However, the left inlet check valve 110 will not allow air to be forced out of the left side of the peristaltic pump tube 102, such as where the compression point of the peristaltic pump tube 102 is rotating in a counter-clockwise direction according to the figure and creating an increasing pressure at the left inlet check valve 110.

The right inlet check valve 111 is positioned on a right side of the inlet fitting 103 in the right tube end 105. The right inlet check valve 111 operates to allow ambient air to be drawn in to the right side of the peristaltic pump tube 102 in the figure. The right inlet check valve 111 is configured to admit air into the peristaltic pump tube 102 when the peristaltic pump tube 102 is being compressed in a counter-clockwise (CCW) direction and when the bypass valve 150 is substantially blocking the bypass conduit 130. However, the right inlet check valve 111 will not allow air to be forced out of the right side of the peristaltic pump tube 102, such as where the compression point of the peristaltic pump tube 102 is rotating in a clockwise direction according to the figure and creating an increasing pressure at the right inlet check valve 111.

A left coupling conduit 128 is coupled to and in fluid communication with the peristaltic pump tube 102 in the region of the left inlet check valve 110. The left coupling conduit 128 further extends to the tire and is coupled to and in fluid communication with the tire.

A right coupling conduit 129 is coupled to and in fluid communication with the peristaltic pump tube 102 in the region of the right inlet check valve 111. The right coupling conduit 129 further extends to the tire and is coupled to and in fluid communication with the tire.

A bypass conduit 130 couples the left coupling conduit 128 to the right coupling conduit 129, wherein air may pass between the left coupling conduit 128 and the right coupling conduit 129 when the bypass conduit 130 is not blocked. The direction of the airflow will depend on the direction of rotation of the tire.

A left outlet check valve 120 is located in the left coupling conduit 128 between the bypass conduit 130 and the self-inflating tire. The left outlet check valve 120 allows pressurized air to pass through the left coupling conduit 128 from the peristaltic pump tube 102 to the tire, but does not allow air to leave the tire via the left coupling conduit 128.

A right outlet check valve 121 is located in the right coupling conduit 129 between the bypass conduit 130 and the self-inflating tire. The right outlet check valve 121 allows pressurized air to pass through the right coupling conduit 129 from the peristaltic pump tube 102 to the tire, but does not allow air to leave the tire via the right coupling conduit 129.

The tire pressure control system 100 further includes a pressure sensing element 153. The pressure sensing element 153 may sense the air pressure inside the tire. The pressure sensing element 153 is in fluidic communication with the air pressure inside the tire and is also in fluidic communication with the ambient air pressure outside the tire. The pressure sensing element 153 includes a link 154 that may transmit a pressure signal to the bypass valve 150.

The position of the pressure sensing element 153 is adjustable. The position of the pressure sensing element 153 will determine how much pressurized air will be added to the self-inflating tire. The position of the pressure sensing element 153 will determine the pressure level of the predetermined target pressure.

The peristaltic pump tube 102 includes an inlet fitting 103. An adjuster body 140 may be installed into the inlet fitting 103, such as by threads. Alternatively, the adjuster body 140 may be held in the inlet fitting 103 by other structures or arrangements. The adjuster body 140 is movable within the inlet fitting 103 for the purpose of allowing a person to mechanically and manually change the pressure setting for air pressure to be maintained within the tire. In some embodiments, the adjuster body 140 and the inlet fitting 103 include threading, wherein the adjuster body 140 may be rotated to move in or out of the inlet fitting 103 and set the predetermined target pressure. In this embodiment, the predetermined target pressure is externally adjustable.

Alternatively, the adjuster body 140 may be internal to the tire, or may only be manipulated from inside the tire. In this embodiment, the adjustor body 140 may only be manipulated when the tire is not fully mounted to a wheel. In this embodiment, the inlet filter 144 may be independent of the adjuster body 140. In this embodiment, the predetermined target pressure is not externally adjustable.

The adjuster body 140 includes an inlet passage 141 that comprises a passage for ambient air to be drawn into the peristaltic pump tube 102. Ambient air drawn into the peristaltic pump tube 102 may then be compressed and forced into the tire, or may be merely retained in the peristaltic pump tube 102 until the quantity of air needs to be compressed and added to the tire. An inlet filter 144 may be positioned in the inlet 141 in order to prevent dirt, moisture, or other unwanted material from entering the peristaltic pump tube 102.

The adjuster body 140 may include a flange 148 or other protrusion or protrusions that are configured to receive and hold an end of a biasing device 146. The adjuster body 140 may therefore increase or decrease the biasing force generated by the biasing device 146 by the adjuster body 140 being moved in or out of the inlet fitting 103.

The other end of the biasing device 146 is received by the pressure sensing element 153. As a result, the biasing device 146 places a biasing force on the pressure sensing element 153. The biasing force opposes the force of the pressure sensing element 153 generated by tire pressure within the self-inflating tire.

The biasing force is related to the predetermined target pressure and sets the predetermined target pressure. A change in the biasing force due to movement of the adjuster body 140 will result in a corresponding change in the predetermined target pressure.

The predetermined target pressure is controlled by the relative position of the adjuster body 140. The adjuster body 140 is configured to be manipulated to select a predetermined target pressure. If a greater tire pressure is desired in the self-inflating tire, then the adjuster body 140 may be moved inward in the inlet fitting 103. This moves the end of the biasing device 146 and increases compression of the biasing device 146, increasing the biasing force generated by the biasing device 146.

If a lesser tire pressure is desired in the self-inflating tire, then the adjuster body 140 may be moved outward in the inlet fitting 103. This relaxes some of the compression on the biasing device and some of the biasing force generated by the biasing device 146.

When the tire pressure in the self-inflating tire is greater than or equal to the predetermined target pressure, then the bypass valve 150 will substantially unblock the bypass conduit 130, wherein the air within the peristaltic pump tube 102 will continue to circulate. Conversely, when the tire pressure in the self-inflating tire is less than the predetermined target pressure, then the bypass valve 150 will substantially block the bypass conduit 130, wherein the air that is compressed by the peristaltic pump tube 102 will be forced into the tire.

FIG. 1 shows the tire pressure control system 100 when the bypass valve 150 is substantially open and the bypass conduit 130 is substantially unblocked. As a result, no appreciable pressure may be generated by the peristaltic pump tube 102. No air may be drawn into or forced out of the peristaltic pump tube 102. Air in the peristaltic pump tube 102 merely circulates around the peristaltic pump tube 102 due to the open, unblocked bypass conduit 130.

A person may decrease the predetermined target pressure by moving the adjuster body 140 outwardly in the inlet fitting 103 and therefore decreasing the biasing force generated by the biasing device 146. As a result, air pressure will not be added to the self-inflating tire until the tire pressure drops below this newer, lower predetermined target pressure.

Likewise, a person may increase the predetermined target pressure by moving the adjuster body 140 inwardly in the inlet fitting 103 and therefore increasing the biasing force generated by the biasing device 146. As a result, air pressure will be added to the self-inflating tire until the tire pressure reaches an equilibrium with this newer, higher predetermined target pressure.

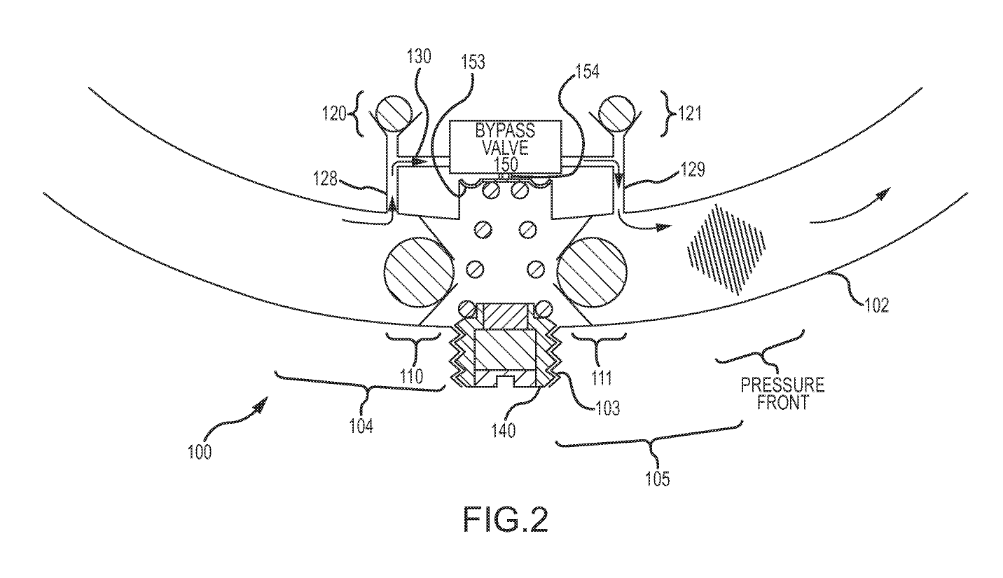

FIG. 2 shows the tire pressure control system 100 wherein a compression point/pressure front is being generated in the peristaltic pump tube 102 as the self-inflating tire rotates. However, as the bypass valve 150 and bypass conduit 130 are open and unblocked, the pressure front merely causes air to be circulated within the peristaltic pump tube 102. No air is drawn into the peristaltic pump tube 102. No air is forced from the peristaltic pump tube 102 into the self-inflating tire.

It should be understood that alternatively the pressure front may travel clockwise instead of counter-clockwise. The operation of the peristaltic pump tube 102 and the tire pressure control system 100 will be unchanged. Therefore, the tire pressure control system 100 is bi-directional and is capable of inflating the self-inflating tire in either rotational direction.

FIG. 3 shows the tire pressure control system 100 wherein a compression point/pressure front is being generated in the peristaltic pump tube 102 as the self-inflating tire rotates. In this figure, the bypass valve 150 and the bypass conduit 130 are blocked and substantially no air travels between the left coupling conduit 128 and the right coupling conduit 129 via the bypass conduit 130. If the self-inflating tire is rotated, a compression point/pressure front will be generated in the peristaltic pump tube 102. Pressurized air from the peristaltic pump tube 102 is forced into the tire as a result of the bypass conduit 130 being blocked by the bypass valve 150. In the example shown in the figure, where the compression point/pressure front is moving in a counter-clockwise direction, the pressurized air will be forced through the left outlet check valve 120 and into the tire. As a result of the presence of the right inlet check valve 111, air will be drawn into the right tube end 105 after the compression point due to the suction created by the rotational travel of the pressure front.

At the left tube end 104, air pressure will increase as the pressure front travels in a counter-clockwise manner around the peristaltic pump tube 102. The rate of pressure increase will depend at least in part on the rotational speed of the self-inflating tire. When the pressure in the peristaltic pump tube 102 exceeds the tire pressure in the self-inflating tire, then the left outlet check valve 120 will open and pressurized air from the peristaltic pump tube 102 will be forced into the self-inflating tire.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention. Accordingly, the scope of the invention should be determined from the following claims.

We claim:

1. A tire pressure control system (100) for a self-inflating tire, with the tire pressure control system (100) comprising:
a left coupling conduit (128) in fluid communication with a left tube end (104) of a peristaltic pump tube (102);
a right coupling conduit (129) in fluid communication with a right tube end (105) of the peristaltic pump tube (102);
a bypass conduit (130) extending between and coupling the left coupling conduit (128) and the right coupling conduit (129); and
a bypass valve (150) configured to block the bypass conduit (130) when the tire pressure is less than a predetermined target pressure, wherein when the bypass valve (150) substantially blocks the bypass conduit (130), then pressurized air generated in the peristaltic pump tube (102) is forced into the self-inflating tire and wherein when the bypass valve (150) does not block the bypass conduit (130), then air is allowed to circulate within the peristaltic pump tube (102).

2. The tire pressure control system (100) of claim 1, with the tire pressure control system (100) further comprising a left outlet check valve (120) in the left coupling conduit (128) and a right outlet check valve (121) in the right coupling conduit (129), wherein the left outlet check valve (120) and the right outlet check valve (121) are located between the bypass conduit (130) and the self-inflating tire.

3. The tire pressure control system (100) of claim 1, wherein when the bypass valve (150) substantially blocks the bypass conduit (130), then pressurized air generated in the peristaltic pump tube (102) is added to the self-inflating tire until the tire pressure substantially equals the predetermined target pressure.

4. The tire pressure control system (100) of claim 1, with the tire pressure control system (100) further comprising an adjuster body (140) configured to be manipulated to select the predetermined target pressure.

5. The tire pressure control system (100) of claim 1, with the bypass valve (150) comprising:
an adjuster body (140) configured to be manipulated to select the predetermined target pressure;
a movable pressure sensing element (153);
a link (154) extending from the pressure sensing element (153); and
a biasing device (146) positioned between the adjuster body (140) and the pressure sensing element (153), with the biasing device (146) placing a biasing force against the pressure sensing element (153), wherein the predetermined target pressure is related to the biasing force.

6. The tire pressure control system (100) of claim 1, with the tire pressure control system (100) further comprising:
a left inlet check valve (110) positioned in the left tube end (104) and configured to admit air into the peristaltic pump tube (102) when the peristaltic pump tube (102) is being compressed in a clockwise (CW) direction and when the bypass valve (150) substantially blocks the bypass conduit (130); and
a right inlet check valve (111) positioned in the right tube end (105) and configured to admit air into the peristaltic pump tube (102) when the peristaltic pump tube (102) is being compressed in a counter-clockwise (CCW) direction and when the bypass valve (150) substantially blocks the bypass conduit (130).

7. The tire pressure control system (100) of claim 1, wherein the predetermined target pressure comprises an adjustable target pressure.

8. The tire pressure control system (100) of claim 1, wherein the predetermined target pressure comprises a manually adjustable target pressure.

9. A tire pressure control system (100) for a self-inflating tire, with the tire pressure control system (100) comprising:
a left coupling conduit (128) in fluid communication with a left tube end (104) of a peristaltic pump tube (102);
a right coupling conduit (129) in fluid communication with a right tube end (105) of the peristaltic pump tube (102);
a bypass conduit (130) extending between and coupling the left coupling conduit (128) and the right coupling conduit (129); and
a bypass valve (150) configured to block the bypass conduit (130) when the tire pressure is less than a predetermined target pressure, with the bypass valve (150) comprising:
an adjuster body (140) configured to be manipulated to select a predetermined target pressure;
a movable pressure sensing element (153);
a link (154) extending from the pressure sensing element (153); and
a biasing device (146) positioned between the adjuster body (140) and the pressure sensing element (153), with the biasing device (146) placing a biasing force against the pressure sensing element (153), wherein the predetermined target pressure is related to the biasing force;
wherein when the bypass valve (150) substantially blocks the bypass conduit (130), then pressurized air generated in the peristaltic pump tube (102) is forced into the self-inflating tire and wherein when the bypass valve (150) does not block the bypass conduit (130), then air is allowed to circulate within the peristaltic pump tube (102).

10. A method of forming a tire pressure control system for a self-inflating tire, with the method comprising:
providing a left coupling conduit in fluid communication with a left tube end of a peristaltic pump tube;
providing a right coupling conduit in fluid communication with a right tube end of the peristaltic pump tube;
providing a bypass conduit extending between and coupling the left coupling conduit and the right coupling conduit; and
providing a bypass valve configured to block the bypass conduit when the tire pressure is less than a predetermined target pressure, wherein when the bypass valve substantially blocks the bypass conduit, then pressurized air generated in the peristaltic pump tube is forced into the self-inflating tire and wherein when the bypass valve does not block the bypass conduit, then air is allowed to circulate within the peristaltic pump tube.

11. The method of claim 10, with the method further comprising providing a left outlet check valve in the left coupling conduit and providing a right outlet check valve in the right coupling conduit, wherein the left outlet check valve and the right outlet check valve are located between the bypass conduit and the self-inflating tire.

12. The method of claim 10, wherein when the bypass valve substantially blocks the bypass conduit, then pressurized air generated in the peristaltic pump tube is added to the self-inflating tire until the tire pressure substantially equals the predetermined target pressure.

13. The method of claim 10, with the method further comprising providing an adjuster body configured to be manipulated to select the predetermined target pressure.

14. The method of claim 10, with providing the bypass valve comprising:
providing an adjuster body configured to be manipulated to select the predetermined target pressure;
providing a movable pressure sensing element;
providing an anvil extending from the pressure sensing element; and
providing a biasing device positioned between the adjuster body and the pressure sensing element, with the biasing device placing a biasing force against the pressure sensing element, wherein the predetermined target pressure is related to the biasing force.

15. The method of claim 10, with the method further comprising:
providing a left inlet check valve positioned in the left tube end and configured to admit air into the peristaltic pump tube when the peristaltic pump tube is being compressed in a clockwise (CW) direction and when the bypass valve substantially blocks the bypass conduit; and
providing a right inlet check valve positioned in the right tube end and configured to admit air into the peristaltic pump tube when the peristaltic pump tube is being compressed in a counter-clockwise (CCW) direction and when the bypass valve substantially blocks the bypass conduit.

16. The method of claim 10, wherein the predetermined target pressure comprises an adjustable target pressure.

17. The method of claim 10, wherein the predetermined target pressure comprises a manually adjustable target pressure.
